(19) United States
(12) Patent Application Publication
(10) Pub. No.: US 2022/0100276 A1
(43) Pub. Date: Mar. 31, 2022

(54) METHOD FOR GENERATING A HAPTIC FEEDBACK FOR AN INTERFACE, AND ASSOCIATED INTERFACE

(71) Applicant: VALEO COMFORT AND DRIVING ASSISTANCE, Créteil Cedex (FR)

(72) Inventors: Stephane Vanhelle, Créteil Cedex (FR); Pedro Adriano, Créteil Cedex (FR)

(73) Assignee: VALEO COMFORT AND DRIVING ASSISTANCE, Créteil Cedex (FR)

(21) Appl. No.: 17/427,409

(22) PCT Filed: Jan. 30, 2020
(86) PCT No.: PCT/EP2020/052246

§ 371 Date: Jul. 30, 2021

(30) Foreign Application Priority Data
Jan. 31, 2019 (FR) 1900953

(51) Int. Cl. G06F 3/01; G06F 3/044; G06T 15/04; G06T 17/20; B60K 35/00

(52) U.S. Cl. CPC G06F 3/016; G06F 3/044; G06T 15/04; G06T 17/20; B60K 2370/158; G06F 2203/04105; B60K 2370/152; B60K 2370/1438; B60K 2370/157; B60K 35/00

(57) ABSTRACT

The invention relates to a method for generating a haptic feedback for a motor vehicle interface (1) comprising: —a screen (4) configured to display an image, —a touch surface (3) arranged above the screen (4) and configured to locate the position as well as to determine a pressure applied by a control element to the touch surface (3), —a haptic feedback device (20) configured to generate a haptic feedback when receiving a control signal, and —a procedural texture generation unit (28) configured to model a textured object and to display an image of the textured object on the screen (4), the method being characterised in that —an image of a textured object generated by the procedural texture generation unit (28) is displayed on the screen (4), —taking into account the location on the touch surface (3) and the pressure (F) applied by the control element, an interaction of said control element with the textured object is modelled, —the effect of the interaction on the textured object is determined, —the haptic feedback device (20) is controlled according to the determined effect of the interaction on the textured object.

The present invention relates to a method for generating sensory feedback for a motor vehicle interface. The present invention also relates to a motor vehicle interface configured so as to implement said method.

In order to simplify motor vehicle instrument panels, manage various interface configurations and improve their appearance, touch screens are increasingly being integrated into the interior of the passenger compartment.

These screens are basically flat, but some touch screens with a certain curvature, blending seamlessly into the dashboard of a motor vehicle, have been developed in recent times.

These screens make it possible to control a large number of functions, such as for example air-conditioning, audio, telephone, navigation and driving assistance functions, to name but a few, and contribute to the appearance of the interior of the passenger compartment. For motor vehicle manufacturers, they also make it possible to give a “signature” of their brand, including through the graphical interfaces of the screens.

A touch screen therefore makes it possible to increase the number of functions able to be controlled by users, with the advantage of being programmable and reconfigurable and able to be displayed temporarily or permanently depending on the context or the activated function. The screen thus includes a multifunctionality option, while at the same time virtualizing the buttons and being customizable. These touch screens, the cost of which is tending to decrease, therefore make it possible to easily adapt to various models and to various ranges of vehicle.

Touch screens are increasingly being equipped with sensory feedback, for example haptic and/or acoustic feedback. The sensory feedback makes it possible for example to reassure the user that his command has effectively been taken into account, thereby making it possible to avoid the occurrence of hazardous situations while driving.

Second of all, by integrating a touch screen, it is also desirable to simulate, for the user, an environment that he knows. Specifically, the screens make it possible for example to display images that may contain objects, such as reliefs or buttons for example. Through the set of lighting and shading effects, the user has a visual perception in relief of the displayed object. Some other images or areas of the image display a surface having a certain surface texture. Depending on the display quality of the screen, the visual appearance is increasingly close to the actual perception of the displayed object by a user.

Some recent developments are additionally proposing to associate sensory feedback with the relief of the image displayed on the touch screen for a result highly similar to that of a 3D relief of a real object. In this case, the haptic feedback has the function not only of confirming or validating a user's choice, but also, from a generally smooth interface, of giving said user a perception of a surface consistent with an image or a displayed object.

A haptic pattern is for example associated at least in certain areas of the image in order to simulate, for the user, a feeling close to the displayed visual pattern.

For example, a texture simulation method that associates a specific haptic pattern with various areas of the screen is known.

For example, to simulate a texture of vertical ridges, some areas adopting the shapes of the ridges are defined in the image for each “rib” or “groove” and a different haptic pattern is associated with each area of different appearance.

During operation, when the user's finger moves horizontally over the smooth surface of the touch screen over the succession of ridges displayed by the screen, he perceives haptic patterns that are generated alternately, reminiscent of the vertical ridges that he is viewing simultaneously on the screen. The aim is therefore to make the user's haptic perception consistent with the image or object displayed on the screen.

This haptic perception of texture, also called “haptic texturing” may however sometimes lack realism.

This is the case for example when the user perceives an offset between the location of a haptic feeling of a relief on the screen and the display thereof. Such an offset may occur for example when the user moves his finger quickly over the screen.

This may also be the case when the user moves his finger in different directions and he does not perceive any texture modifications in the direction of movement of the finger while he is viewing asymmetric textures on the screen.

These inaccuracies in the haptic feeling are due in particular to the computing time required to process information.

To improve this, one solution consists in performing direction and trajectory calculations that make it possible to take into account in particular the speed of movement of the finger, the pressing pressure of the finger exerted on the screen or the direction of movement of the finger in order to determine the haptic effect to be generated. These calculations attempt for example to anticipate the movement of the finger over the screen in order to better synchronize the perception of the haptic feedback that is generated with the texture displayed on the screen so that it is as realistic as possible.

Returning to the example of the vertical ridges, the direction of movement of the finger is measured, for example, in order to adapt the haptic pattern depending on whether the user moves his finger horizontally or vertically. The speed of movement of the finger is also measured in order to anticipate the trajectory and to adapt the pattern of the generated haptic feedback to the increase in speed of movement of the finger.

However, these calculations require a lot of computing resources.

Imperfections in the perception of the haptic feedback are also still observed.

These perception imperfections are due mainly to the computing time required in particular to measure the speed and the direction of movement of the user's finger over the touch screen and then to calculate the haptic feedback to be generated that corresponds to these particular data.

Another imperfection stems from the inability to reflect the haptic feeling of the interaction, for example of the finger, in the form of a control element with a deformable relief in the real world. Specifically, assuming, in the real world, a 3D surface with small ribs or protrusions made of elastic, depending on the material, in particular its elasticity, and on the pressing force applied to such a relief, the user's haptic perception when sliding his finger over this relief is different. Specifically, the greater the pressing force and the more elastic the material, the more the user will “crush” parts in relief in the real world and “eliminate” the surface ruggedness, as it were. On the other hand, for example, for a highly rigid “stone” relief having no elasticity, this elimination or crushing effect does not exist.

Moreover, the known solutions are static images, that is to say that the displayed image does allow the user to perceive a certain relief, such as for example grooves and ribs, and the user perceives this relief haptically through appropriate feedback, but the known solutions do not allow a dynamic interaction between the displayed relief, on the one hand, and the haptic feedback, on the other hand. As a result, the haptic and visual representation may appear somewhat rigid to the user.

One of the aims of the present invention is therefore to at least partially rectify at least one of the above drawbacks by proposing a method for generating sensory feedback for a motor vehicle interface, which method exhibits improved performance and makes it possible to add a component resulting from a dynamic interaction with the user.

To this end, one subject of the invention is a method for generating sensory feedback for a motor vehicle interface comprising:
a screen configured so as to display an image,
a touch surface arranged on top of the screen and configured so as to locate the position and to determine a pressing force of a control element on the touch surface,
a sensory feedback device configured so as to generate sensory feedback upon reception of a control signal, and
a procedural texture generation unit configured so as to model a textured object and to display an image of the textured object on the screen, characterized in that
an image of a textured object generated by the procedural texture generation unit is displayed on the screen,
taking into account the location on the touch surface and the pressing force of the control element, an interaction of this control element with the textured object is modeled,
the effect of the interaction on the textured object is determined,
the sensory feedback device is controlled on the basis of the determined effect of the interaction on the textured object.

The method may have one or more of the following aspects, taken on their own or in combination:

According to one aspect, the effect of the interaction on the textured object is displayed on the screen.

The procedural texture generation unit, during the modeling of the textured object, takes into account for example at least one of the following parameters included in the following group of parameters: roughness of the textured object, deformability of the material of the textured object, elasticity of the textured object, displacement or movement of the textured object.

The textured object may correspond to a dashboard covering, in particular a skin, for example leather, or a control button.

According to one embodiment, the textured object has a dynamic surface that varies over time, in particular in the form of waves.

According to another aspect, acoustic feedback is emitted, accompanying the effect of the interaction on the textured object.

The textured object is for example represented in the form of a 3D polygonal mesh.

The invention also relates to a motor vehicle interface comprising:
a procedural texture generation unit configured so as to model a textured object and to display an image of the textured object,
a screen configured so as to display an image of a textured object generated by said procedural texture generation unit,
a touch surface arranged on top of the screen and configured so as to locate the position and to determine a pressing force of a control element on the touch surface, and
a sensory feedback device configured so as to generate sensory feedback upon reception of a control signal,
characterized in that the procedural texture generation unit for generating procedural textures on the screen is configured so as
to model an interaction of the control element with the textured object, taking into account the location on the touch surface and the pressing force of the control element,
to determine the effect of the interaction on the textured object, and
to control the sensory feedback device on the basis of the determined effect of the interaction on the textured object.

The interface may have one or more of the following aspects, taken on their own or in combination:

According to one aspect, the procedural texture generation unit, during the modeling of the textured object, is configured so as to take into account at least one of the following parameters included in the following group of parameters: roughness of the textured object, deformability of the material of the textured object, elasticity of the textured object, displacement or movement of the textured object.

The textured object corresponds for example to a dashboard covering, in particular a skin, for example leather, or a control button.

The interface may furthermore comprise an acoustic emitter configured so as to emit an acoustic signature accompanying the effect of the interaction on the textured object.

The textured object in the virtual space is represented in the form of a 3D polygonal mesh.

Further features and advantages of the invention will emerge from the following description, given by way of example and in no way limiting, with reference to the appended drawings, in which:

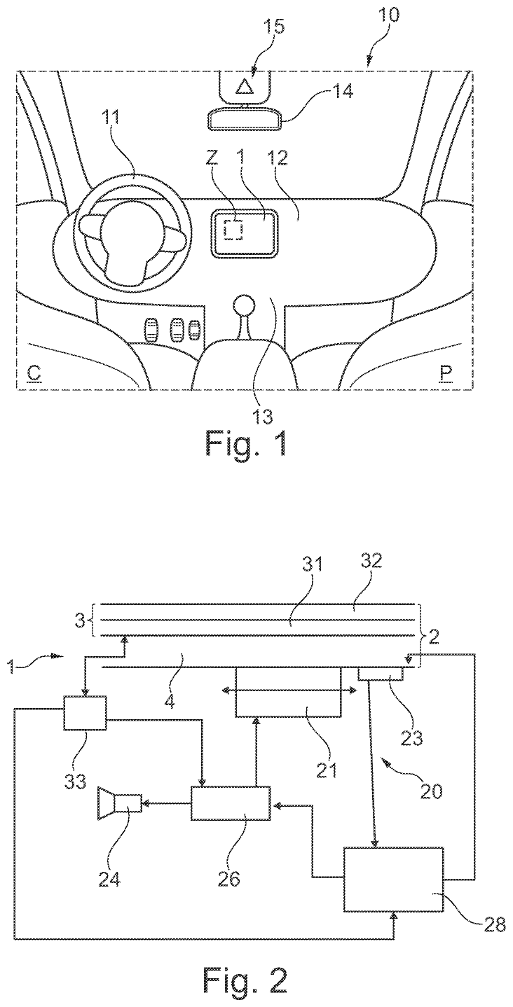

FIG. 1 shows a front portion of a motor vehicle passenger compartment,

FIG. 2 shows a schematic/synoptic side view of an interface,

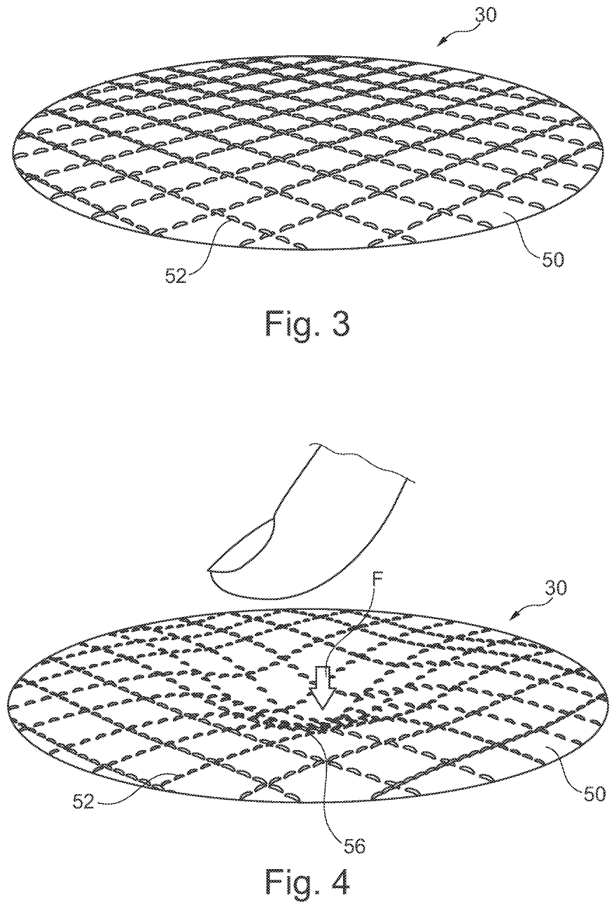

FIG. 3 shows a perspective view of one example of a portion of a textured surface in its virtual space without any constraints,

FIG. 4 shows a perspective view of one example of a textured surface according to FIG. 3 in its virtual space with pressing of a finger,

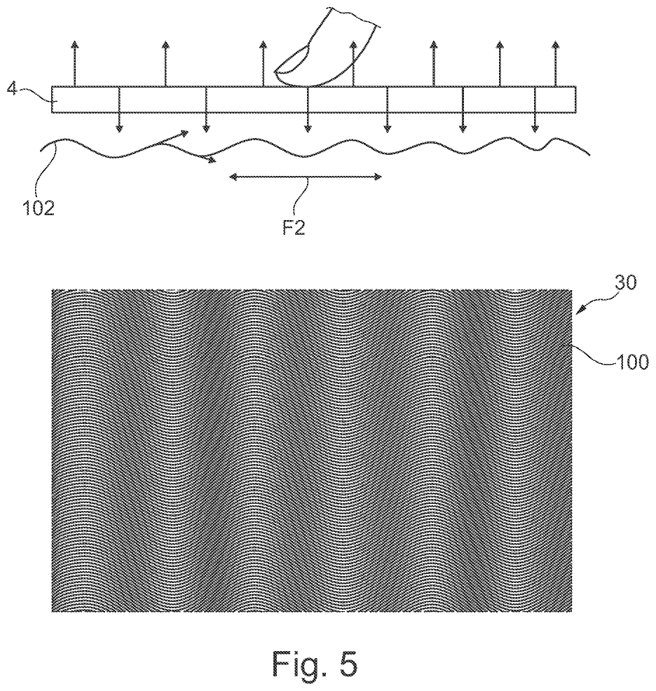

FIG. 5 shows one example of an interface with dynamic texturing that evolves over time.

In these figures, the same elements bear the same reference numbers.

The term “procedural texture” is a term used in digital graphics. In this context, a procedural texture is a texture that is created based on a mathematical description (for example an algorithm) and not based on data recorded for example in bitmap format as an image. This method has the advantage that the textures are able to be highly precise and are independent of the resolution. Procedural textures may be for example 2D or 3D, and are often used to represent natural materials such as wood, granite, metal or stone.

The “natural” appearance of these procedural textures is generally achieved using fractal noise or turbulence functions, which may be used as a representation of a randomness observed in nature.

The following embodiments are examples. Although the description refers to one or more embodiments, this does not necessarily mean that each reference relates to the same embodiment, or that the features apply only to one embodiment. Individual features of various embodiments may also be combined in order to provide other embodiments.

FIG. 1 shows a schematic view of a front portion of a motor vehicle passenger compartment 10 seen from the rear portion of the vehicle.

The passenger compartment 10 comprises in particular a driver's seat C positioned behind a steering wheel 11 and a dashboard 12, a passenger seat F, an interior mirror 14, a ceiling light module 15, also called a dome, located near the interior mirror 14 in the upper central portion of the front portion of the passenger compartment 10, and a central console 13 located between the two seats of the front portion of the passenger compartment 10, an interface 1 being installed in the dashboard 12. Of course, the interface 1 may be arranged at other locations in the passenger compartment 10, such as for example in the central console 13 or any other suitable location.

As may be seen in FIG. 2 showing a schematic view of the interface 1, the interface 1 comprises a screen 4, a touch surface 3 arranged on top of the screen 4 and a sensory feedback device 20. The screen 4 and the touch surface 3 form a touch screen 2.

According to one exemplary embodiment, the interface 1 makes it possible for example to control at least one function of a motor vehicle component in order in particular to control functions of an air-conditioning system, of an audio system, of a telephone system or even of a navigation system. The interface 1 may also be used for example to control interior lights, a central locking system, a sunroof, hazard lights or mood lights. This interface 1 may also be used to control power windows, to control the positioning of the exterior mirrors or even to control the movement of motorized seats. It makes it possible for example to select a destination postal address or a name from a directory, the air-conditioning system settings, the activation of a function, or the selection of a music track from a list.

The touch surface 3 is for example a capacitive touch screen equipped with means for determining or measuring a pressing force applied to the touch surface 3.

The capacitive touch screen in this case comprises at least one capacitive sensor 31, a front plate 32 arranged on the capacitive sensor 31 and a controller 33.

The capacitive sensor 31 makes it possible to detect a variation in capacitance on the surface of the front plate 32. The capacitive touch screen is able to detect and determine the X and Y spatial coordinates for example of a control element touching the touch surface 3.

The control element may be a finger or any other activation means (for example a stylus) of the user.

The capacitive sensor 31 and the front plate 32 are at least partially transparent. The capacitive sensor 31 is for example formed of an array of electrodes extending over all or part of the surface of the screen. The electrodes are for example made of ITO (indium-tin oxide), which allow the sensor 31 to be transparent.

The rigidity of the capacitive touch screen is achieved by way of the rigid front plate 32 (or contact plate), such as a glass or polycarbonate plate. The front plate 32 arranged on the capacitive sensor 31 faces the user once installed in the passenger compartment.

The screen 4, such as a TFT (“Thin-Film transistor”) screen or an OLED screen or an LCD screen, is for example configured so as to display information or images associated in particular with the manipulation of the interface 1.

The screen 4 is arranged underneath the capacitive sensor 31. The screen 4 is configured so as to display an image formed of a predetermined number of pixels each identified by a position X, Y in the image. A pixel is a (rectangular or square) basic surface element of a digital image. A pixel may be formed from a plurality of sub-pixels: red, green, blue for example. For example, a screen 4 with a resolution of 480*800 comprises 384000 pixels.

The images displayed by the screen 4 may be of any kind, in particular digital synthetic images, in particular color ones.

The touch surface 3 comprises at least one active area Z. The one or more active areas Z may extend over part or all of the interface 1. Contact of the control element in the active area Z may allow the sensory feedback device 20 to be controlled.

An image of a textured object, as will be described in more detail later on, is for example displayed in the active area Z.

The touch surface 3 is configured so as to locate the X, Y position of the control element on the touch surface 3 and to determine the pressing force.

To this end, the interface 1 comprises at least one pressing sensor 23 configured so as to measure a parameter representative of a pressing force exerted on the touch surface 3 (FIG. 2).

The pressing sensor 23 is for example a capacitive sensor configured so as to measure a distance between the movable portion and the fixed portion in a direction perpendicular to the surface of the touch screen 2. A variation in the distance between the movable portion and the fixed portion is a parameter representative of pressing exerted on the touch screen 2. For one specific exemplary embodiment, reference may be made for example to the interface described in document EP3340022 in the name of the Applicant.

The pressing force may also be measured by other means, such as for example by inductive measurement or by ultrasonic measurement or by measurement of deformation by way of strain gauges or FSR (for “Force Sensing Resistor”) sensors. To measure the pressing force, the touch surface 3 is for example installed in a manner floating or suspended in a support frame (not shown), with a strain gauge interposed between the support frame and the touch surface 3.

The sensory feedback device 20 is configured so as to generate sensory feedback, for example haptic and/or acoustic feedback, upon receiving a control signal.

To this end, the sensory feedback device 20 comprises a haptic feedback module 21 and/or an acoustic feedback loudspeaker 24.

Such a control signal for sensory feedback comprises for example a control signal for controlling the haptic feedback module 21 and/or a control signal for controlling the acoustic feedback loudspeaker 24 and/or the absence of sensory feedback.

The acoustic feedback from the acoustic feedback loudspeaker 24 may have various patterns and/or frequencies and/or amplitudes and/or durations.

The term “haptic” denotes tactile feedback with physical contact with the touch screen 2.

The haptic feedback may be created by for example making the touch screen 2 vibrate, either in a direction parallel to a plane defined by the screen 4 or in a direction perpendicular to this plane, The haptic feedback is then touch-based feedback. The haptic feedback is thus a vibratory or vibrotactile signal.

The control signal for controlling the haptic feedback module H may have various patterns and/or frequencies and/or phase offsets and/or amplitudes and/or durations, generally of between 20 and 30 msec. The pattern (or trend or shape) has for example what is called a simple shape: linear, square, half-sine, triangle, etc. or what is called a complex shape, comprising a combination of simple shapes or a curve. The pattern may also be symmetrical or asymmetrical as a function of time depending on the effect that it is desired to simulate. A pattern is symmetrical as a function of time if the displacement duration in one direction of displacement is equal to that in the opposite direction. A pattern is asymmetrical as a function of time it the duration in one direction of displacement is longer or shorter than that in the opposite direction.

To this end, the haptic feedback module comprises at least one vibratory actuator 21 connected to the touch screen 2.

The vibratory actuator 21 is for example an ERM (for “Eccentric Rotating Mass”), also called “vibrating motor” or flyweight motor. According to another example, the vibratory actuator 21 is electromagnetic (a solenoid). It may also be based for example on a technology similar to that of the loudspeaker (“Voice Coil”). The vibratory actuator 21 is for example an LRA (for “Linear Resonant Actuator”), also called “linear motor”. According to another example, the vibratory actuator 21 is piezoelectric.

The haptic feedback is a vibratory signal such as a vibration produced by a sinusoidal control signal or by a control signal, comprising a pulse or a succession of pulses, sent to the vibratory actuator 21. The vibration is for example directed in the plane of the touch screen 2 or orthogonally to the plane or else directed in a combination of these two directions.

The touch screen 2 and the vibratory actuator 21 are for example elements of a movable portion of the interface 1 that is connected, by at least one damping element, to a fixed portion intended to be fixed to the motor vehicle.

The sensory feedback device 20 may also comprise a processing unit 26 having one or more microcontrollers, having memories and programs suitable in particular for implementing the method for generating sensory feedback from the interface, for modifying the display of the screen 4, and for processing the information provided by the touch surface 3. This is for example the on-board computer of the motor vehicle.

The interface 1 furthermore comprises a procedural texture generation unit 28. This procedural texture generation unit 28 comprises one or more microcontrollers, having appropriate memories and programs. These may be dedicated microcontrollers and memories, but they may also be the same components as those used for the processing unit 26, used in shared mode. As explained above, the procedural textures are generated based on mathematical models and for example using fractal or turbulence functions.

For one example of a procedural texture generation unit, reference may be made for example to document U.S. Pat. No. 6,674,433 or to document EP 2 599 057. These two documents describe how it is possible to generate and model a textured object in a virtual space, that is to say its mathematical representation. Software for editing and generating procedural textures is marketed for example under the name “Substance” (registered trademark) by Allegorithmic (registered trademark). These documents deal only with visual effects for the processing of textured objects in a virtual space.

Therefore, in the present invention, the procedural texture generation unit 28 is configured so as to model a textured object and to display an image of the textured object on the screen 4. The textured object is therefore modeled in a virtual space.

A textured object is understood to mean an object in the broad sense, with an external surface exhibiting specific aspects. A textured object corresponds for example to a dashboard covering, in particular a skin, for example leather, or else a control button.

One example of a textured object 30 is shown in FIG. 3. This is a membrane 50 in particular in the shape of a flat disc, for example made of leather and with quilted leather gridded seams 52.

In the real world, when touching a quilted leather object, it is possible to feel the roughness of the leather and the furrows/grooves formed by the gridded seams 52. The membrane 50 may also be pushed down by pressing on it.

In the real world, an object may be characterized by its surface appearance, its roughness, its ruggedness, its deformability elasticity depending on external stresses or environmental factors.

The procedural texture generation unit 28 makes it possible to represent such a real object with its characteristics in a virtual space (through modeling).

A virtual representation corresponds to a mathematical description of the textured object 30 with its characteristics, in particular using a suitable mesh, for example in the form of a 3D polygonal mesh, as used in video games to obtain a visual surface appearance close to reality.

The procedural texture generation unit 28 is also programmed to be able to compute modifications to the textured object 30 on the basis of its deformation properties for example.

Thus, as shown in FIG. 4, a force F applied to the membrane 50 will have the effect of creating a hollow 56 or recess in the center of the membrane 50.

As may be seen in FIG. 2, the procedural texture generation unit 28 is connected to the controller 33 of the capacitive sensor 31, on the one hand, and to the pressing sensor 23, on the other hand.

It therefore receives, at input, the X and Y position of the pressing and also the pressing force applied to the touch surface 3 by a control element, such as for example a user's finger or a stylus.

Taking these input data into account, the procedural texture generation unit 28 is programmed to compute the modifications to the textured object 30 in its virtual space, in particular changes in shape, as shown for example in FIG. 4. The pressing force, with its location, are therefore also modeled and transposed into the virtual space, that is to say the mathematical space in which the textured object 30 is represented.

The procedural texture generation unit 28 therefore determines an interaction of the textured object 30 with the control element through transposition of the X, Y pressing position and also from the pressing force of the control element in the virtual space where the textured object 30 is modeled.

The procedural texture generation unit 28 then controls the sensory feedback device 20 on the basis of the determined effect of the interaction on the textured object 30, which results in the user feeling a haptic effect that resembles what he might feel on a real object, while his finger is placed only on a smooth touch screen 3.

Pushing of the finger may for example be simulated by asymmetric accelerations perpendicular to the touch surface and generated by the sensory feedback device 20, that is to say for example cycles of rapid downward acceleration (with reference to the arrangement in FIG. 2) followed by a slower ascent. Edge or rib effects may be achieved through rapid upward accelerations.

Of course, the procedural texture generation unit 28 also displays the effect of the interaction on the textured object 30, such as for example the deformation, for example as in FIG. 4, on the screen 4. An acoustic signature, such as acoustic feedback accompanying the effect of the interaction on the textured object 30, may also be emitted by the loudspeaker 24. In the present example, the acoustic signature may be that of a finger rubbing on leather.

FIG. 5 shows another exemplary embodiment of the interface.

The bottom of this FIG. 5 shows, with reference 100, an image of a textured object 30 displayed by the touch screen 2.

In this example, unlike the example of FIGS. 3 and 4, the textured object is not static at the outset, but involves reliefs that move over time, for example with a back and forth movement as indicated by the double-headed arrow F2. The textured object 30 is therefore in the form of a dynamic surface that varies over time, such as waves that, when a force is applied to them, are crushed due to a certain deformation elasticity.

This textured object 30 is generated based on a mathematical model, which is indicated, in a simplified manner above the image 100, by a curve 102. This involves for example sinusoidal functions the peaks of which move in a back and forth movement along the surface of the touch screen 2.

When the touch surface 3 is pressed, the procedural texture generation unit 28 modifies the textured object 30, here the waves, for example by crushing them and spreading them. This effect of the interaction will be visible on the touch screen 2 to the user and will also be perceptible to him, given that the unit 28 will control the sensory feedback device 20 accordingly. 8y increasing the pressing force, the user will perceive greater spreading/flattening of the waves.

It is also possible to use the image of the textured object in FIG. 5 in another way. Let us assume that the textured object in the image 100 is initially fixed and flat, for example in the manner of a body of water.

Pressing the touch screen 2 generates a hollow and waves at the location where the finger is placed on the surface and, when the finger moves, the waves move with the finger, the pressing point still corresponding to a hollow.

In this case too, it is the procedural texture generation unit 28 that will first generate the deformations of the textured object in the virtual space so as then to control the sensory feedback device 20, on the one hand, and the touch screen 2 so as to display the deformation of the textured object 30, on the other hand.

Yet more cases may generally be observed. Depending on the pressure exerted (P=F/S) and depending on the simulated rigidity of the texture (for example plastic or metal) and depending on the surface state of the textured object, for example a very solid coarse surface grain of significant roughness, the surface is supposed to deform under the force of the pressing, but the surface grain is not, and for example remains constant.

In this case, the procedural texture generation unit 28 may take into account the fact that, in the virtual space, the surface of the textured object, for example a plate with bumps, is deformed, but the bumps themselves are not.

The effect of the interaction of the textured object 30 in the virtual space may for example take into account the angle tangent to the deformed surface on contact, the average static and dynamic coefficient of friction of the finger on the surface as a function of the simulated material, or else the speed of movement of the finger over the touch surface.

In another case, as explained with reference to FIGS. 3 and 4, the procedural texture generation unit 28 may take into account the fact that the texture grain (for example bumps) changes as a function of pressure.

In this case, the procedural texture generation unit 28 takes into account a macroscopic deformation (deformation of the surface) and a microscopic deformation (deformation of the bumps) as a function of the applied pressure.

The textured object 30 may also for example represent a control button, a keypad key or a scrolling cursor (or “slider”).

In this case for example, the procedural texture generation unit 28 may for example simulate the pushing of the button as a function of a pressure exerted on the touch surface 3 and control the sensory feedback device 20 such that the user feels the pressing of the finger, on the one hand, and hears for example the clicking sound of a mechanical switch.

It will therefore be understood that the interface according to the invention makes it possible to considerably widen the field of application of haptic feedback touch screens 4.

1. A method for generating sensory feedback for a motor vehicle interface the interface comprising:
a screen configured so as to display an image,
a touch surface arranged on top of the screen and configured so as to locate the position and to determine a pressing force of a control element on the touch surface,
a sensory feedback device configured so as to generate sensory feedback upon reception of a control signal, and
a procedural texture generation unit configured to model a textured object and to display an image of the textured object on the screen,
the method comprising:
displaying the image of a textured object generated by the procedural texture generation unit on the screen;
taking into account the location on the touch surface and the pressing force of the control element, modelling an interaction of this control element with the textured object;
determining the effect of the interaction on the textured object; and
controlling the sensory feedback device on the basis of the determined effect of the interaction on the textured object.

2. The method as claimed in claim 1, wherein the effect of the interaction on the textured object is displayed on the screen.

3. The method as claimed in claim 1, wherein the procedural texture generation unit, during the modeling of the textured object, takes into account at least one of the following parameters: roughness of the textured object, deformability of the material of the textured object, elasticity of the textured object, displacement or movement of the textured object.

4. The method as claimed in claim 1, wherein the textured object corresponds to a dashboard covering or a control button.

5. The method as claimed in claim 1, wherein the textured object has a dynamic surface that varies over time in the form of waves.

6. The method as claimed in claim 1, wherein acoustic feedback is emitted, accompanying the effect of the interaction on the textured object.

7. The method as claimed in claim 1, wherein the textured object is represented in the form of a 3D polygonal mesh.

8. A motor vehicle interface comprising:
a procedural texture generation unit configured so as to model a textured object and to display an image of the textured object;
a screen configured so as to display an image of a textured object generated by said procedural texture generation unit;
a touch surface arranged on top of the screen and configured so as to locate the position and to determine a pressing force of a control element on the touch surface; and
a sensory feedback device configured so as to generate sensory feedback upon reception of a control signal,
wherein the procedural texture generation unit for generating procedural textures on the screen is configured to:
model an interaction of the control element with the textured object, taking into account the location on the touch surface and the pressing force of the control element,
to determine the effect of the interaction on the textured object, and
to control the sensory feedback device on the basis of the determined effect of the interaction on the textured object.

9. The interface as claimed in claim 8, wherein the procedural texture generation unit, during the modeling of the textured object, is configured so as to take into account at least one of the following parameters: roughness of the textured object, deformability of the material of the textured object, elasticity of the textured object, displacement or movement of the textured object.

10. The interface as claimed in claim 8, wherein the textured object corresponds to a dashboard covering or a control button.

11. The interface as claimed in claim 8, further comprising: an acoustic transmitter configured so as to emit an acoustic signature accompanying the effect of the interaction on the textured object.

12. The interface as claimed in claim 8, wherein the textured object in the virtual space is represented in the form of a 3D polygonal mesh.
